(19) United States
(12) Patent Application Publication
(10) Pub. No.: US 2025/0144726 A1
(43) Pub. Date: May 8, 2025

(54) MODULAR ROTOR BLADE ASSEMBLY

(71) Applicant: KENNAMETAL INC., Latrobe, PA (US)

(72) Inventors: Vishwanath Lande, Bangalore (IN); Prashanth Suresh, Bangalore (IN); Steef Pronk, Mistelgau (DE); Michael Zunner, Mistelgau (DE); Akshay A., Bangalore (IN); Deepak S. Achar, Bangalore (IN); Balachandra Hegde, Bangalore (IN)

(21) Appl. No.: 18/940,015

(22) Filed: Nov. 7, 2024

(30) Foreign Application Priority Data
Nov. 7, 2023 (IN) 202341075974

(51) Int. Cl. B23C 5/22

(52) U.S. Cl. CPC B23C 5/2265

(57) ABSTRACT

A modular rotor blade assembly includes a pair of cover plates; a base plate disposed between the pair of cover plates; a wedge disposed within a slot formed in a perimeter of the base plate; and a rotor blade attached to the wedge. One or more cover plates and/or the rotor blade with corresponding wedge are capable of being replaced without the need to replace the base plate, thereby reducing the cost or replacing the entire rotor blade assembly.

### RELATED APPLICATION DATA

The present application claims priority pursuant to 35 U.S.C. § 119(a) to Indian Patent Application number 202341075974 filed Nov. 7, 2023 which is incorporated herein by reference in its entirety.

### FIELD OF THE DISCLOSURE

The invention pertains to a milling machine that reduces particle size. More particularly, the invention relates to a milling machine that reduces product size by using a modular rotor blade assembly.

### BACKGROUND OF THE DISCLOSURE

There are many types of milling machines. For example, an impact rotor mill is used to reduce products of a hardness of less than 3 Mohs. One such impact rotor mill is a type commercially available from Lessine SA. It enables a very fine output particle size.

The product to grind is injected into the center of a circular vertical stator-rotor. The rotor turning at a high speed “sucks” the product and projects the product towards the output, then it passes through the rotating rotor blade assembly. The output of the product is situated in the circumference of the impact rotor mill.

A rotor blade assembly is typically made of steel and operates between 20-130 m/s circumference as a typical value to reduce the product size by abrasion. However, one problem that is encountered is the frequent replacement of the entire rotor blade assembly due to wear of the rotor blades. As a result, desired production rate of the output of the product is deteriorated due to excessive machine down time.

### SUMMARY OF THE DISCLOSURE

The problem of frequent replacement of the entire rotor blade assembly resulting in excessive machine down time in a milling machine is solved by providing a modular rotor blade assembly with replaceable rotor blades.

In one aspect of the invention, a modular rotor blade assembly comprises a pair of cover plates; a base plate disposed between the pair of cover plates; a wedge disposed within a slot formed in a perimeter of the base plate; and a rotor blade attached to the wedge, wherein one or more cover plates and/or the rotor blade with corresponding wedge are capable of being replaced without the need to replace the base plate.

In another aspect of the invention, a modular rotor blade assembly comprises a pair of cover plates, each cover plate including a plurality of mounting holes. A base plate is disposed between the pair of cover plates, the base plate including a plurality of threaded mounting holes. A wedge is disposed within a slot formed in a perimeter of the base plate, the slot being formed with a reverse taper; a rotor blade attached to the wedge. A threaded fastener is received within each of the plurality of threaded mounting holes and each of the plurality of mounting holes for attaching each cover plate to the base plate, wherein one or more of the pair of cover plates and/or the rotor blade with corresponding wedge are capable of being replaced without the need to replace the base plate.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an exploded view of a modular rotor blade assembly in accordance with an embodiment of the invention;

FIG. 2 is a base plate according to an embodiment of the invention;

FIG. 3 is a cover plate according to an embodiment of the invention; and

FIG. 4 is the rotor blade assembly of FIG. 1 when assembled.

### DETAILED DESCRIPTION OF THE DISCLOSURE

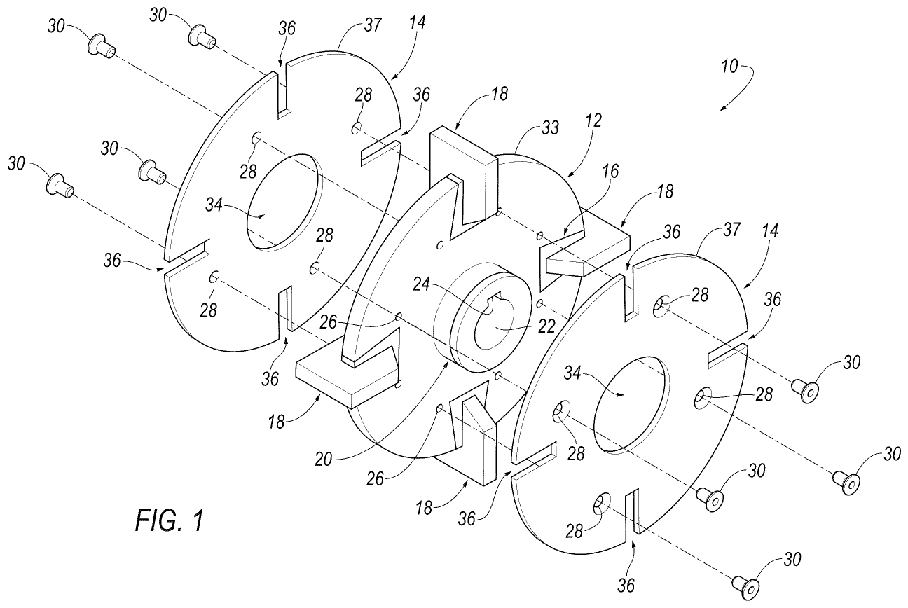

Referring now to FIGS. 1-4, a modular rotor blade assembly 10 is shown according to an embodiment of the invention. In general, the modular rotor blade assembly 10 includes four basic components:
1) a disc-like base plate 12;
2) a disc-like cover plate 14 disposed on each side of the base plate 12;
3) a wedge 16; and
4) a rotor blade 18 brazed to a corresponding wedge 16.

In the illustrated embodiment, the modular rotor blade assembly 10 has a total of four wedges 16 with a corresponding blade 18 attached to the corresponding wedge 16 that are spaced equidistantly about the periphery of the base plate 12 (i.e., approximately 90 degrees apart from each other). However, it should be appreciated that the invention is not limited by the number of wedges 16 and blades 18, and that the invention can be practiced with any desirable number of wedges 16 and blades 18.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

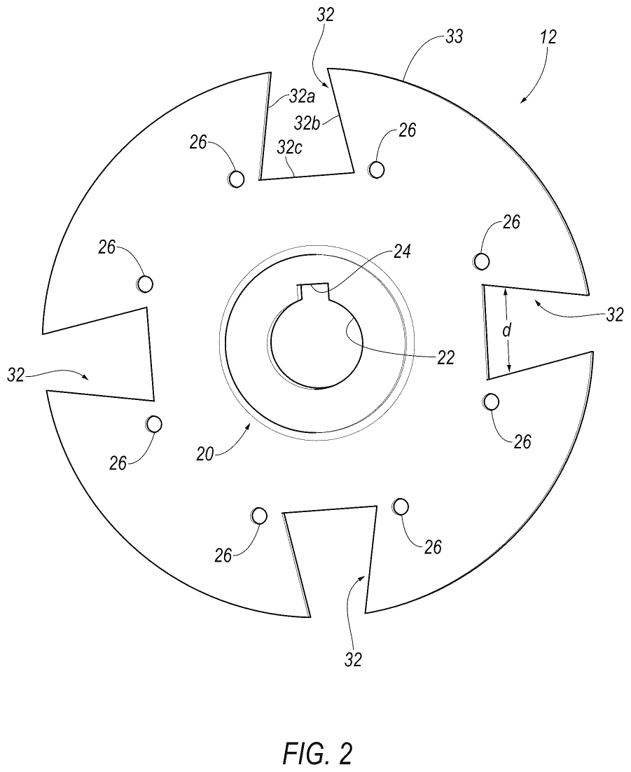

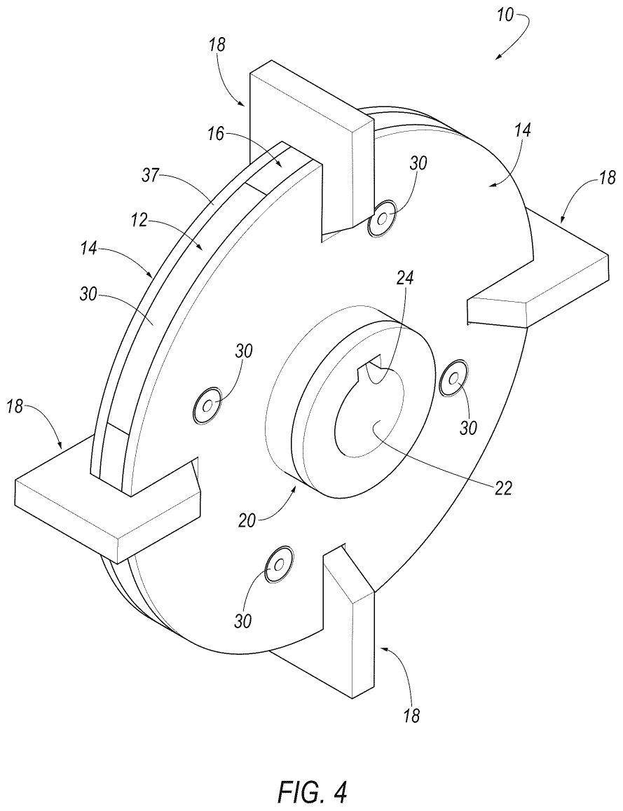

Referring now to FIG. 2, the base plate 12 includes a central hub 20 having a cavity 22 and a keyway 24 extending radially outward from the cavity 22 that act as a guide to properly position the modular rotor blade assembly 10 to a machine drive mechanism (not shown) for rotating the modular rotor blade assembly 10. The base plate 12 also includes one or more threaded mounting holes 26 corresponding in number to countersunk mounting holes 28 formed in each of the cover plates 14. In the illustrated embodiment, the base plate 12 includes a total of eight threaded mounting holes 26 and each cover plate 14 has a total of four countersunk mounting holes 28. In the illustrated embodiment, one cover plate 14 is substantially identical to the other cover plate 14, except for the locations of the countersunk mounting holes 28. Specifically, the countersunk mounting holes 28 for one cover plate 14 are offset from the mounting holes 28 for the other cover plate 14 that is mounted on the opposite side of the base plate 12 by about 45 degrees, as shown in FIG. 2. When aligned with each other, the threaded mounting holes 26 and countersunk mounting holes 28 are capable of receiving threaded fasteners 30, such as screws, and the like, for attaching each of the cover plates 14 to the base plate 12, as shown in FIG. 4.

The base plate 12 includes one or more slots 32 formed around a perimeter 33 of the base plate 12. In the illustrated embodiment, the base plate 12 has a total of four slots 32 spaced equidistantly around the perimeter 33 of the base plate 12. It should be appreciated that the invention is not limited by the number of slots 32, and that the invention can be practiced with any desired number of slots 32, so long as the number of slots 32 corresponds to the number of wedges 16. Each slot 32 includes a pair of angled side walls 32a, 32b and a bottom wall 32c extending between the angled side walls 32a, 32b. The shape of each slot 32 is substantially identical to the shape of the wedge 16 such that the wedge 16 is capable of being received within a corresponding slot 32. The side walls 32a, 32b are formed with a reverse taper such that the distance, d, between the side walls 32a, 32b is greatest proximate the bottom wall 32c and smallest proximate the perimeter of the base plate 12, as shown in FIG. 2. In this manner, the wedge 16 and rotor blade 18 mounted within the slot 32 are prevented from unwanted movement in the z-direction (i.e., radial direction) during operation.

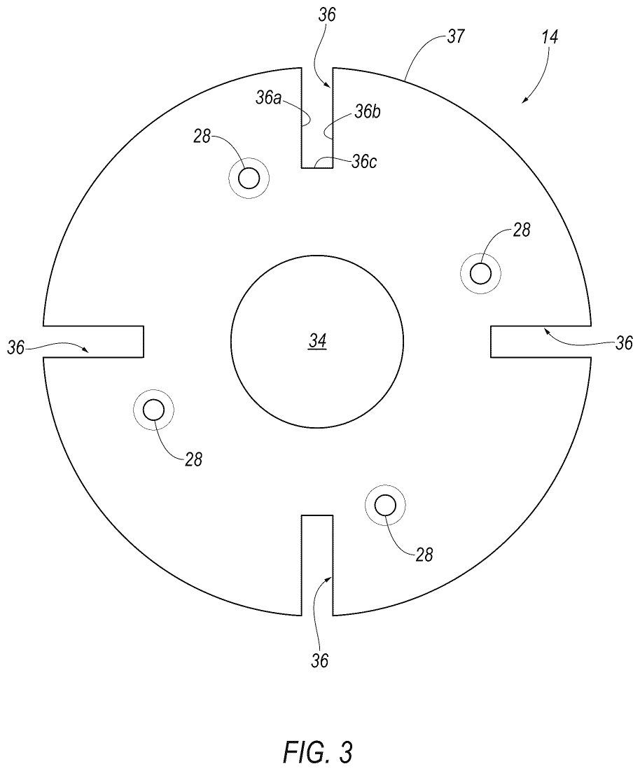

Referring now to FIG. 3, the cover plate 14 has a central opening 34 capable of receiving the central hub 20 of the base plate 12. A perimeter 37 of the cover plate 14 also includes one or more slots 36 corresponding in number to the one or more slots 32 of the base plate 12. Each slot 36 include a pair of side walls 36a, 36b and a bottom wall 36c extending between the side walls 36a, 36b. In the illustrated embodiment, the side walls 36a, 36b are substantially parallel to each other, and the bottom wall 36c is substantially perpendicular to each of the side walls 36a, 36b. Each slot 36 is capable of receiving a corresponding rotor blade 18, as shown in FIG. 4.

As described above, the modular rotor blade assembly 10 enables the user to replace the cover plates 14 and wedge 16 with attached rotor blade 18 when these components become worn without the need to replace the entire rotor blade assembly, as in conventional rotor blade assemblies. This is accomplished by simply removing one or both of the cover plates 14 and removing one or more wedges 16 with attached rotor blade 18 and replacing the worn parts with new parts without the need to replace the entire rotor blade assembly (i.e., including the base plate 12). As a result, the modular rotor blade assembly 10 of the invention is more cost effective and reduces machine down time, as compared to conventional rotor blade assemblies.

The patents and publications referred to herein are hereby incorporated by reference.

Having described presently preferred embodiments the invention may be otherwise embodied within the scope of the appended claims.

1. A modular rotor blade assembly comprising:
a pair of cover plates;
a base plate disposed between the pair of cover plates;
a wedge disposed within a slot formed in a perimeter of the base plate; and
a rotor blade attached to the wedge,
wherein one or more cover plates and/or the rotor blade with corresponding wedge are capable of being replaced without the need to replace the base plate.

2. The modular rotor blade assembly according to claim 1, wherein the slot formed in the perimeter of the base plate is formed with a reverse taper to prevent unwanted movement of the wedge and the rotor blade in a radial direction during operation.

3. The modular rotor blade assembly according to claim 1, wherein each cover plate includes a slot formed in a perimeter for receiving the rotor blade.

4. The modular rotor blade assembly according to claim 3, wherein the slot includes a pair of side walls parallel to each other and a bottom wall perpendicular to the pair of side walls.

5. The modular rotor blade assembly according to claim 1, wherein the base plate includes a central hub with a cavity and a keyway.

6. The modular rotor blade assembly according to claim 5, wherein each cover plate includes a central opening for receiving the central hub of the base plate.

7. The modular rotor blade assembly according to claim 1, wherein the base plate includes a plurality of threaded mounting holes, wherein each cover plate includes a plurality of mounting holes, and wherein each of the plurality of threaded mounting holes and each of the plurality of mounting holes are capable of receiving a threaded fastener to fasten the pair of cover plates to the base plate.

8. A modular rotor blade assembly comprising:
a pair of cover plates, each cover plate including a plurality of mounting holes;
a base plate disposed between the pair of cover plates, the base plate including a plurality of threaded mounting holes;
a wedge disposed within a slot formed in a perimeter of the base plate, the slot being formed with a reverse taper;
a rotor blade attached to the wedge; and
a threaded fastener received within each of the plurality of threaded mounting holes and each of the plurality of mounting holes for attaching each cover plate to the base plate,
wherein one or more of the pair of cover plates and/or the rotor blade with corresponding wedge are capable of being replaced without the need to replace the base plate.

9. The modular rotor blade assembly according to claim 8, wherein each cover plate includes a slot formed in a perimeter for receiving the rotor blade.

10. The modular rotor blade assembly according to claim 9, wherein the slot includes a pair of side walls parallel to each other and a bottom wall perpendicular to the pair of side walls.

11. The modular rotor blade assembly according to claim 8, wherein the base plate includes a central hub with a cavity and a keyway.

12. The modular rotor blade assembly according to claim 11, wherein each cover plate includes a central opening for receiving the central hub of the base plate.
